(19) United States
(12) Patent Application Publication
(10) Pub. No.: US 2025/0386801 A1
(43) Pub. Date: Dec. 25, 2025

(54) ELECTRICAL MUSCLE STIMULATION FOR ANIMAL CONTROL

(71) Applicant: AgX Global, Inc., Cambridge, MA (US)

(72) Inventors: Callum TAYLOR, Cambridge, MA (US); Samuel AUBIN, Cambridge, MA (US)

(73) Assignee: AgX Global, Inc., Cambridge, MA (US)

(21) Appl. No.: 19/236,581

(22) Filed: Jun. 12, 2025

Related U.S. Application Data
(60) Provisional application No. 63/662,513, filed on Jun. 21, 2024.
(60) Provisional application No. 63/717,578, filed on Nov. 7, 2024.

(51) Int. Cl. A01K 15/02; A01K 11/00

(52) U.S. Cl. CPC A01K 15/022; A01K 11/008

(57) ABSTRACT

Systems and methods for virtual fencing are provided herein. A virtual fencing device may include an electrode configured to perform electrical muscle stimulation (EMS). The device may include a positioning system configured to determine a position of the device. The device may include a microcontroller engaged with the electrode and the positioning system. The microcontroller may be configured to activate the electrode in response to the position of the device relative to one or more virtual boundaries.

### CROSS-REFERENCE TO RELATED APPLICATIONS

This application claims priority to U.S. Provisional Application No. 63/662,513, filed Jun. 21, 2024 and U.S. Provisional Application No. 63/717,578, filed Nov. 7, 2024, which are incorporated by reference in their entireties.

### FIELD OF DISCLOSURE

This application generally relates to a device and system for virtual fencing.

### BACKGROUND

Virtual fencing devices are devices primarily used to keep animals within a boundary or muster animals to move from one boundary to another. Conventional virtual fencing devices utilize one or more of high voltage electric shocks, auditory signals, and/or vibration to keep animals within the boundary. The high voltage electric shocks are analogous to cattle prods which discharge high voltage to scare an animal into moving from their current position.

### SUMMARY

In some embodiments, a virtual fencing device is provided. The device may include an electrode that may be configured to perform electrical muscle stimulation (EMS). The device may include a positioning system configured to determine a position of the device. The device may include a microcontroller engaged with the electrode and the positioning system. The microcontroller may be configured to activate the electrode in response to the position of the device relative to one or more virtual boundaries.

In some embodiments, a method is provided. The method may include receiving, by a computing system comprising at least one processor, one or more virtual boundaries. The method may include receiving, by the computing system, a first position of a virtual fencing device. The method may include determining, by the computing system, a first distance between the first position of the virtual fencing device and the one or more virtual boundaries. The method may include determining, by the computing system, the first distance is below a threshold distance. The method may include activating, by the computing system, an electrode on the virtual fencing device that may be configured to perform EMS in response to the determining that the first distance is below the threshold distance. The method may include receiving, by the computing system, a second position of the virtual fencing device. The method may include determining, by the computing system, a second distance between the second position and the one or more virtual boundaries. The method may include determining, by the computing system, the second distance is above the threshold distance. The method may include deactivating, by the computing system, the electrode on the virtual fencing device in response to the determining that the second distance is above the threshold distance.

In some embodiments, a virtual fencing device is provided. The device may include an electrode that may be configured to perform EMS. The device may include a positioning system configured to determine a position of the device. The device may include a communication system configured to communicate with a central server and/or a mesh network storing one or more virtual boundaries. The device may include a rechargeable power system comprising a lithium-ion capacitor. The device may include an inertial measurement unit configured to determine a direction and an acceleration of the virtual fencing device. The device may include one or more biometric sensors configured to gather biometric data. The device may include a microcontroller engaged with the electrode, the positioning system, the communication system, the rechargeable power system, the inertial measurement unit, and the one or more biometric sensors. The microcontroller may be configured to communicate the biometric data via the communication system. The microcontroller may be configured to activate the electrode in response to one or more of the position of the device relative to the one or more virtual boundaries, the direction of the device, and the acceleration of the device.

In some embodiments, a positioning method is provided. The method may use time of flight trilateration in lieu of traditional positioning systems. The method may utilize Bluetooth or other radiofrequency protocols for the purpose of finding distances between devices. The method may use microcontroller logic or analog circuits to determine the time delta between sending and receiving a radio frequency message. The method may use microcontroller logic or analog circuits to determine the phase delta of a radio frequency message received by three or more antennas in proximity. The method may include microcontroller logic and circuitry that sends and receives signals from at least one central device with a known location and processes the time delta to trilaterate the position of an animal. To know the location of the device without ambiguity, three devices with known locations can be used. The method may be utilized for the purpose of virtually fencing animals using a variety of stimuli. The method may be utilized for the purpose of tracking an animal's location. The method may be used as a mechanism to track the relative proximity of animals to one another over time. The method may be used to find mating and/or maternal pairs of animals.

### BRIEF DESCRIPTION OF THE FIGURES

The accompanying drawings, which are incorporated herein and form part of the specification, illustrate the present disclosure and, together with the description, further serve to explain the principles of the present disclosure and to enable a person skilled in the relevant art(s) to make and use embodiments described herein.

FIG. 1 depicts a block diagram of an illustrative computing environment, in accordance with example embodiments.

FIG. 2A depicts a perspective view of an illustrative virtual fencing device, in accordance with example embodiments.

FIG. 2B depicts a perspective view of an illustrative virtual fencing device, in accordance with example embodiments.

FIG. 2C depicts a perspective view of an illustrative virtual fencing device, in accordance with example embodiments.

FIG. 3A depicts a perspective view of an illustrative virtual fencing device including snap fit connectors, in accordance with example embodiments.

FIG. 3B depicts a block diagram of an illustrative virtual fencing device, in accordance with example embodiments.

FIG. 4 depicts an example of a virtual fencing device in use, in accordance with example embodiments.

FIG. 5 depicts example regions of use of a virtual fencing device, in accordance with example embodiments.

FIG. 6A depicts an illustrative electrode configuration, in accordance with example embodiments.

FIG. 6B depicts an illustrative electrode configuration, in accordance with example embodiments.

FIG. 7A depicts an example placement of a virtual fencing device, in accordance with example embodiments.

FIG. 7B depicts an example placement of a virtual fencing device, in accordance with example embodiments.

FIG. 8A depicts an example response to an illustrative electrode configuration, in accordance with example embodiments.

FIG. 8B depicts an example response to an illustrative electrode configuration, in accordance with example embodiments.

FIG. 9 depicts an example implementation of a virtual fencing device, in accordance with example embodiments.

FIG. 10A depicts an example implementation of a virtual fencing device, in accordance with example embodiments.

FIG. 10B depicts an example implementation of a virtual fencing device, in accordance with example embodiments.

FIG. 11 depicts a flowchart of an example process of virtual fencing, in accordance with example embodiments.

FIG. 12 depicts a flowchart of an example process of time in flight positioning integrated within virtual fencing, in accordance with example embodiments.

FIG. 13 depicts an example implementation of a virtual fencing device using traditional positioning systems, in accordance with example embodiments.

FIG. 14 depicts an example implementation of a virtual fencing device using traditional positioning systems and time of flight positioning, in accordance with example embodiments.

FIG. 15 depicts an example implementation of animal networks configured to determine positioning of peripheral units, in accordance with example embodiments.

FIG. 16 depicts a flowchart of a time-of-flight calculation process involving central and peripheral devices, in accordance with example embodiments.

FIG. 17 depicts a block diagram of an example computing device for one or more virtual fencing system components, in accordance with example embodiments.

The features of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. Additionally, generally, the left-most digit(s) of a reference number identifies the drawing in which the reference number first appears. Unless otherwise indicated, the drawings provided throughout the disclosure should not be interpreted as to-scale drawings.

### DETAILED DESCRIPTION

Virtual fencing devices provide the ability to fence in animals without the need to install, in some cases, miles of fencing. As described above, current virtual fencing devices utilize one or more of high voltage electric shocks, auditory signals, and/or vibration. The auditory signals and vibration may scare the animal for some time, but the animal may become accustomed to them which defeats their purpose. The animals may withstand the electric shocks in order to break through the virtual boundaries. In response, some virtual fencing devices continuously induce electric shocks to the animal until it has returned to the virtual area. Traditional technologies induce higher voltages and current to cause neurons to fire uncontrollably, leading to intense pain. However, discharging high voltage electric shocks repeatedly for long periods of time raises ethical concerns. In fact, some jurisdictions have banned the use of electric shock technology on animals.

To account for the deficiencies in conventional virtual fencing devices, disclosed herein are improved systems for virtual fencing. Embodiments can include a virtual fencing device. Embodiments can include a process of virtual fencing. The virtual fencing device may include one or more electrodes that may be configured to perform EMS. An electrode control module may activate the one or more electrodes to cause muscle contraction which may induce a physical response from an animal to prevent it from walking in the same direction. EMS may apply a low voltage and current pulse that may produce minimal discomfort to an animal compared to an electric shock. For example, one or more of frequency, pulse width, and/or amplitude of a signal may be modulated to activate a muscle or induce a sensory feeling in the nervous system, as opposed to inducing intense pain.

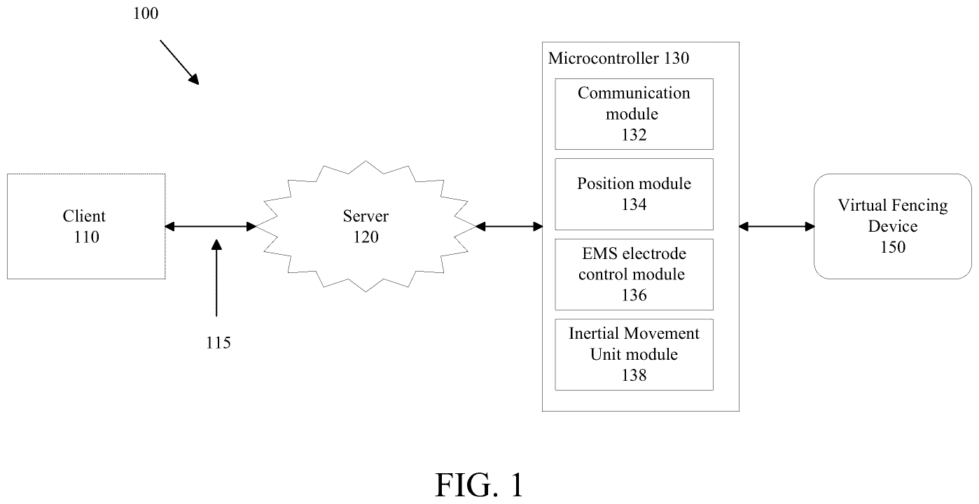

FIG. 1 is a block diagram illustrating an illustrative computing environment 100 for a virtual fencing device, according to example embodiments. As shown, the computing environment 100 may include a client 110, a server 120, a microcontroller 130, and a virtual fencing device 150 communicating via network 115.

Network 115 may be of any suitable type, including individual connections via the Internet, such as cellular or Wi-Fi networks. In some embodiments, network 115 may connect terminals, services, and mobile devices using direct connections, such as radio frequency identification (RFID), near-field communication (NFC), Bluetooth™, low-energy Bluetooth™ (BLE), Wi-Fi™, ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 115 may include any type of computer networking arrangement used to exchange data. For example, network 115 may be the Internet, a private data network, virtual private network using a public network and/or other suitable connection(s) that enables components in computing environment 100 to send and receive information between the components of computing environment 100.

Clients 110 may be representative of one or more computing devices. For example, clients 110 may be representative of a desktop terminal, a laptop computer, a tablet computer, a smartphone, etc. Any type of computing device that allows an access to the server 120 through the network 115 should be considered within the scope of this disclosure. Furthermore, the functionality described within this disclosure can be distributed in any fashion. For example, functionality of the server 120 may be performed by one or more clients 110 and vice versa.

As described above, the microcontroller 130 may include multiple software modules configured to control portions of the virtual fencing device 150. In some embodiments, the multiple software modules may include, but are not limited to, one or more of a communication module 132, a position module 134, an electrode control module 136, and an inertial measurement unit module 138. Each of the communication module 132, the position module 134, the electrode control module 136, and the inertial measurement unit module 138 may include one or more software modules. The one or more software modules may include collections of code or instructions stored on a media (e.g., memory of microcontroller 130) that represent a series of machine instructions (e.g., program code) that implements one or more algorithmic steps. The machine instructions may be the actual computer code the microcontroller 130 interprets to implement the instructions or, alternatively, may be a higher level of coding of the instructions that are interpreted to obtain the actual computer code. The one or more software modules may also include one or more hardware components. One or more aspects of an example algorithm may be performed by the hardware components (e.g., circuitry) itself, rather than as a result of the instructions.

The communication module 132 may be configured to communicate with at least one of a central server 120 and a mesh network of devices. The mesh network of devices may include one or more clients 110. The communication module 132 may communicate with the server 120 through network 115. The microcontroller 130 may receive virtual boundaries via the communication module 132 from the server 120 and/or the mesh network. The communication module 132 may actively request updates to virtual boundaries from the server 120 and/or the mesh network. In some embodiments, the communication module 132 may be configured to receive updates to virtual boundaries without requesting the updates.

The position module 134 may be configured to determine the position of the virtual fencing device 150. The position may be based on direction and distance. The position module 134 may include any position system including, but not limited to, phased array antennas, trilateration, triangulation, time of flight, and/or received signal strength indication (RSSI) with a signal-to-noise ratio (SNR) determination. The position module 134 may utilize one or more of local radio frequency (RF) networks (e.g., other RF devices in close range), cell towers, and/or satellites in determining the position of the virtual fencing device 150. The position module 134 may be configured to determine the position of the virtual fencing device relative to one or more virtual boundaries received by the communication module 132. Microcontroller 130 may utilize the determinations in instructing electrode control module 136. For example, if position module 134 determines that the virtual fencing device 150 is near or beyond a virtual boundary, microcontroller 130 may use that information to instruct electrode control module 136 to activate the one or more electrodes.

The electrode control module 136 may be configured to control the one or more electrodes on the virtual fencing device 150. Electrode control module 136 may include instructions for any type of signal to transmit to the one or more electrodes. For example, electrode control module 136 may cause the electrodes to stimulate muscles with one or more of monophasic signals, biphasic signals, burst signals, rectangular signals, sinusoidal signals, and/or triangular signals. Electrode control module 136 may vary the voltage, current, and/or amplitude of any of the signals. For example, if position module 134 determines that virtual fencing device 150 is beyond a virtual boundary and the distance between the virtual fencing device 150 and the virtual boundary is increasing, microcontroller 130 may instruct electrode control module 136 to intensify the signal. Electrode control module 136 may increase the voltage and/or current to the virtual fencing device 150. If the position module 134 determines that the virtual fencing device 150 is returning to the virtual boundary, microcontroller 130 may instruct electrode control module 136 to decrease the intensity of the signal. In some embodiments, electrode control module 136 may change the signal type in response to microcontroller 130 instructions to intensify the signal. For example, the signal frequency may be increased to intensify the signal. A frequency between about 1 Hz and about 40 Hz may create a tactile sensation for the stimulated muscles. A frequency between about 40 Hz and about 120 Hz may induce muscle contraction for the stimulated muscles.

The inertial measurement unit module 138 may be configured to determine a direction and acceleration of the virtual fencing device 150. Inertial measurement unit module 138 may include instructions to determine the direction and acceleration of the virtual fencing device 150 and communicate the determinations to microcontroller 130. Microcontroller 130 may utilize the determinations in instructing the electrode control module 136. For example, if inertial measurement unit module 138 determines that virtual fencing device 150 is moving in a direction towards a virtual boundary, microcontroller 130 may instruct electrode control module 136 to activate and/or intensify the signal to the electrodes.

In various embodiments, the stages of the illustrative computing environment 100 can provide unidirectional or bidirectional communications (as indicated in FIG. 1) by and between the client 110 and the server 120. In various embodiments, one or more of the stages can operate in a serial or parallel manner with other stages of the computing environment 100. It can further be noted that the depicted architecture for the computing environment 100 is simply intended for illustrative purposes and that the computing environment 100 can be arranged differently (i.e., components or stages can be connected in different manners) or include additional components or stages.

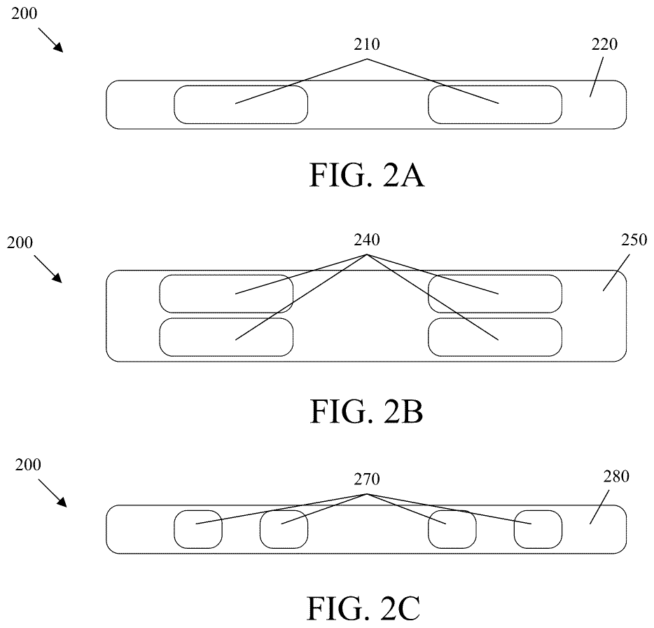

FIGS. 2A-C are perspective views of an illustrative virtual fencing device 200, in accordance with example embodiments. Virtual fencing device 200 may include one or more electrodes that may be configured to perform EMS. As shown in FIG. 2A, virtual fencing device 200 may include two electrodes 210 each disposed on a side of a neckband 220. As shown in FIG. 2B, virtual fencing device 200 may include four electrodes 240 configured such that two electrodes 240 are disposed on each of two sides of a neckband 250. As shown in FIG. 2C, virtual fencing device 200 may include a plurality of electrodes 270 disposed at various points along a neckband 280. Virtual fencing device 200 may be virtual fencing device 150. Microcontroller 130 may be configured to independently control each of the electrodes of virtual fencing device 200.

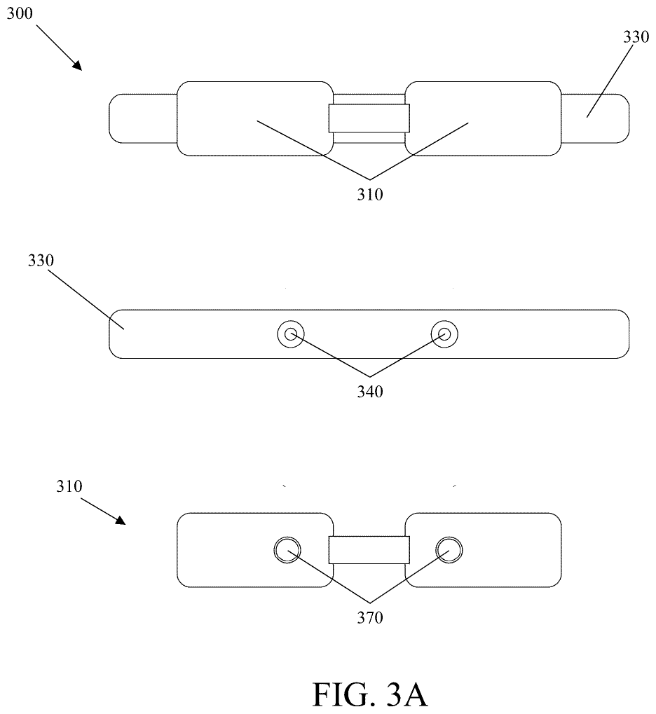

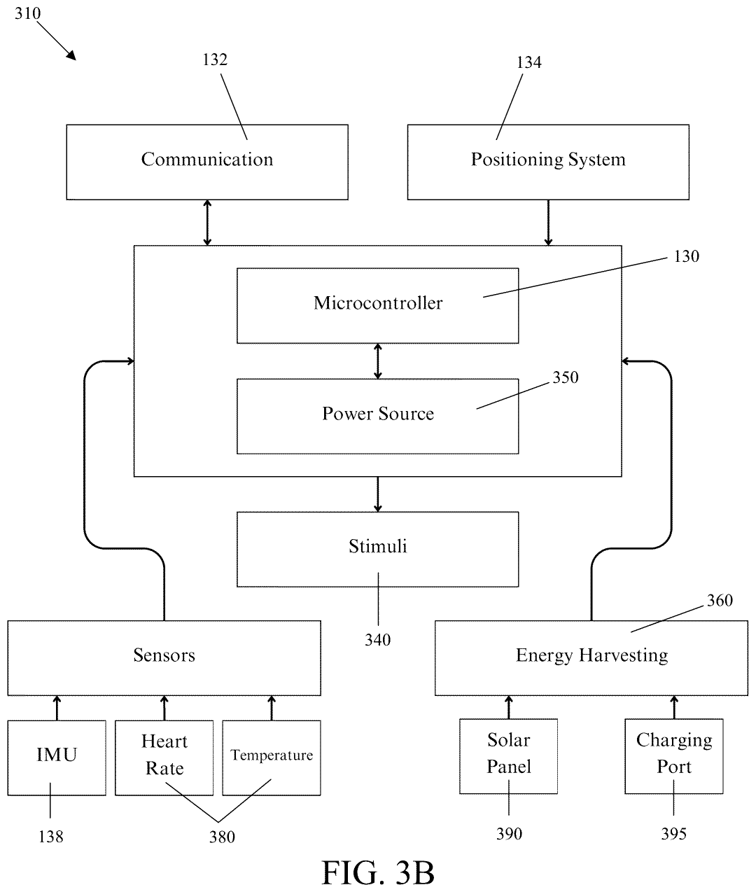

FIG. 3A is a perspective view of an illustrative virtual fencing system 300, in accordance with example embodiments. Virtual fencing system 300 may include a virtual fencing device 310 and a neckband 330. Snap fit electrodes 340 that may be configured to perform EMS may be disposed on the neckband 330 such that the snap fit electrodes 340 may be configured to contact the skin of an animal the neckband 330 is placed on. Virtual fencing device 310 may include snap fit connectors 370 configured to interface with the snap fit electrodes 340. The snap fit connection may enable electrical communication between the virtual fencing device 310 and the snap fit electrodes 340. In some embodiments, the snap fit electrodes 340 may be engaged with one or more conductive pins (e.g., a pogo pin) such that the snap fit electrodes 340 may have a longer reach from a neckband 330. For example, when used on an animal, the pogo pin may enable the snap fit electrodes 340 to contact the skin of the animal through any hair between the neckband 330 and the skin. In some embodiments, the one or more conductive pins may include a plastic portion and a silver capping portion.

Virtual fencing device 310 may be virtual fencing device 150. Virtual fencing device 310 may include a microcontroller 130 configured to control the operation of virtual fencing device 310. Electrode control module 136 may be configured to control electrodes 340 by transmitting a signal to electrodes 340. Microcontroller 130 may instruct electrode control module 136 in operating the electrodes 340. Microcontroller 130 may use the determinations from at least one of the position module 134 and the inertial measurement unit module 138 relative to virtual boundaries received via communication module 132 in instructing electrode control module 136.

FIG. 3B is a block diagram of an illustrative virtual fencing device 310, in accordance with example embodiments. Virtual fencing device 310 may include a power source 350 engaged with microcontroller 130. Power source 350 may include a rechargeable system or a replaceable system. Power source 350 may be engaged with an energy harvesting unit 360 configured to provide energy to the rechargeable system. The rechargeable system may include a hybrid super capacitor storage device. The hybrid super capacitor storage device may include a lithium-ion capacitor. In some embodiments, energy harvesting unit 360 may include one or more of a solar panel 390 and/or a charging port 395. The lithium-ion capacitor may extend the virtual fencing device 310 lifespan, mitigate issues of low and high temperature battery cut-off, mitigate danger from battery combustion, and allow quick re-charging (e.g., approximately one minute). The lithium-ion capacitor may be recharged via charging port 395 or via inductive charging.

Virtual fencing device 310 may include one or more biometric sensors 380. The biometric sensors 380 may include at least one of heart rate and temperature sensors. The one or more biometric sensors 380 may be configured to monitor the biometrics of an animal. Microcontroller 130 may be engaged with the one or more biometric sensors 380. Microcontroller 130 may store biometric data gathered by the one or more biometric sensors 380 and/or may use communication module 132 to communicate biometrics to server 120 and/or a mesh network of devices.

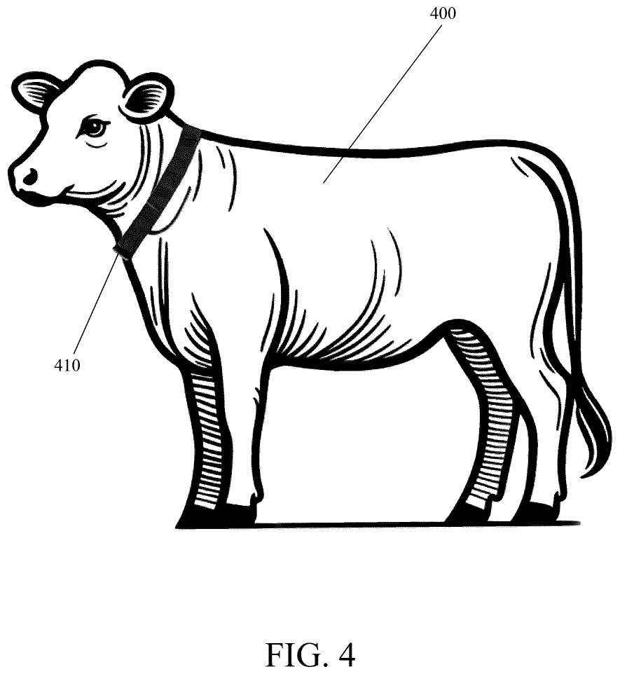

FIG. 4 shows an example of a virtual fencing system 410 in use, in accordance with example embodiments. As shown, a virtual fencing system 410 may be used with an animal 400. The animal 400 may be livestock. The virtual fencing system 410 may include one of virtual fencing device 200 or virtual fencing system 300. The virtual fencing system 410 may be disposed about the neck of the animal 400 using a neckband. In some embodiments, the neckband may include an elastic material configured to conform to the animal's shape and size or may include a mechanism to adjust the size of the neckband for different types and sizes of animals. In some embodiments, the neckband may include synthetic or natural fabrics. Allowing the neckband to conform and/or be adjusted to the animal's size may mitigate the danger of the neckband slipping off, becoming snagged, being chewed, or being pulled off the animal.

In some embodiments, virtual fencing system 410 may include other stimuli in addition to electrodes including but not limited to other electrical stimuli, auditory stimuli, and vibratory stimuli. The auditory stimuli may be produced by one or more speakers engaged with virtual fencing system 410. The vibratory stimuli may be produced by one or more vibration mechanisms. The one or more vibration mechanisms may include a DC motor engaged with virtual fencing system 410. In some embodiments, microcontroller 130 may activate one or more of the other stimuli prior to activating the electrodes.

Virtual fencing system 410 may include one or more biometric sensors. The biometric sensors may include at least one of heart rate and temperature sensors. The biometric sensors may be configured to gather biometric data of animal 400 and transmit the biometric data to microcontroller 130. Microcontroller 130 may store the biometric data and/or transmit the data to server 120 via communication module 132. Microcontroller 130 may use the biometric data to monitor the health of the animal 400.

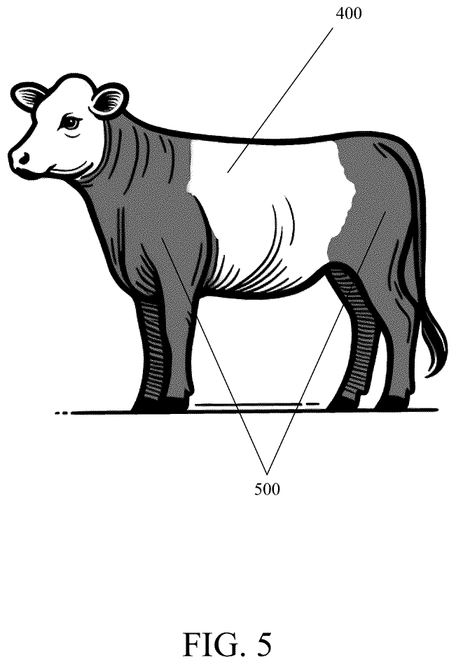

FIG. 5 shows example regions of use of a virtual fencing device, in accordance with example embodiments. As shown, when used with animal 400, electrodes that may be configured to perform EMS may be placed at any point in the regions 500 on the animal 400. Electrodes in these regions 500 may induce muscle contraction preventing the animal 400 from moving the contracted muscle. For example, electrodes may be placed at muscles including, but not limited to, one or more of the cervical trapezius, the brackiocephalicus, and/or the omotransversarius.

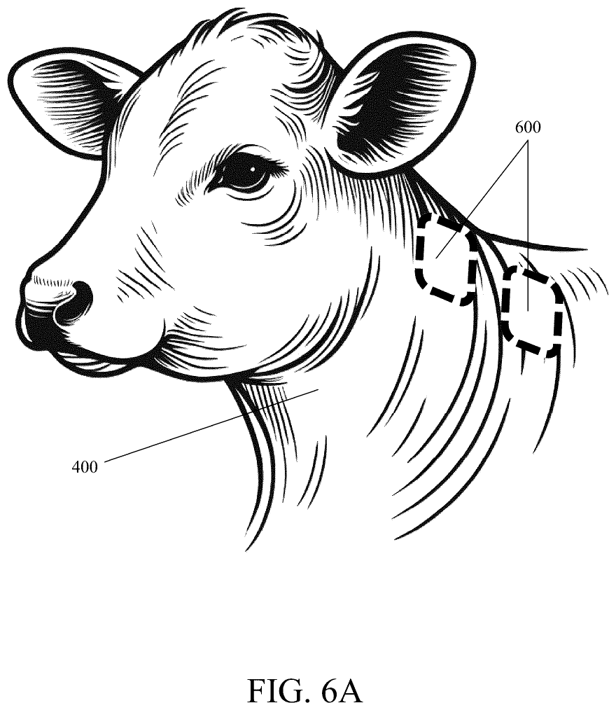

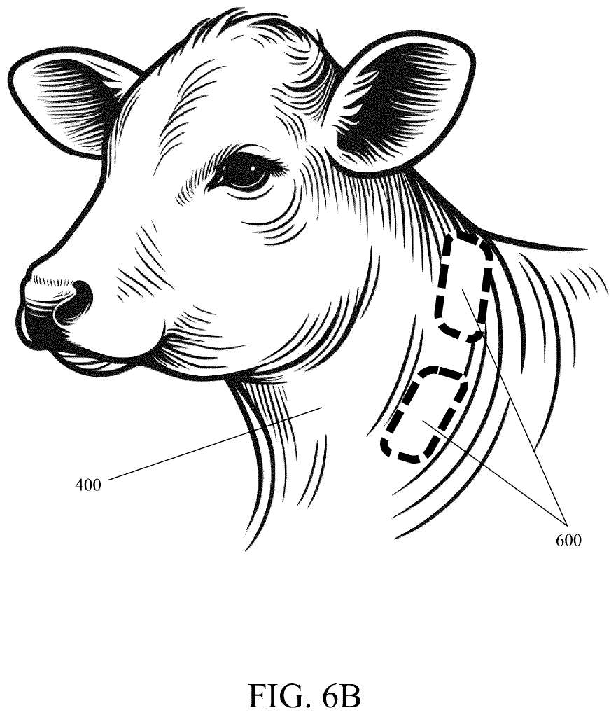

FIG. 6A shows an illustrative configuration of electrodes in use, in accordance with example embodiments. The electrodes 600 may be configured as shown in FIG. 2B. In some embodiments, the electrodes 600 may be adhered to the animal 400 with one or more adhesives. The microcontroller 130 may be in a housing configured to be adhered to the animal 400 with one or more adhesives. The adhesion may be on the skin layer such that the electrodes 600 may be in contact with the skin.

FIG. 6B shows an illustrative configuration of electrodes in use, in accordance with example embodiments. The electrodes 600 may be configured as shown in FIG. 2C. In some embodiments, the electrodes 600 may be adhered to the animal 400 with one or more adhesives. The microcontroller 130 may be in a housing configured to be adhered to the animal 400 with one or more adhesives. The adhesion may be on the skin layer such that the electrodes 600 may be in contact with the skin.

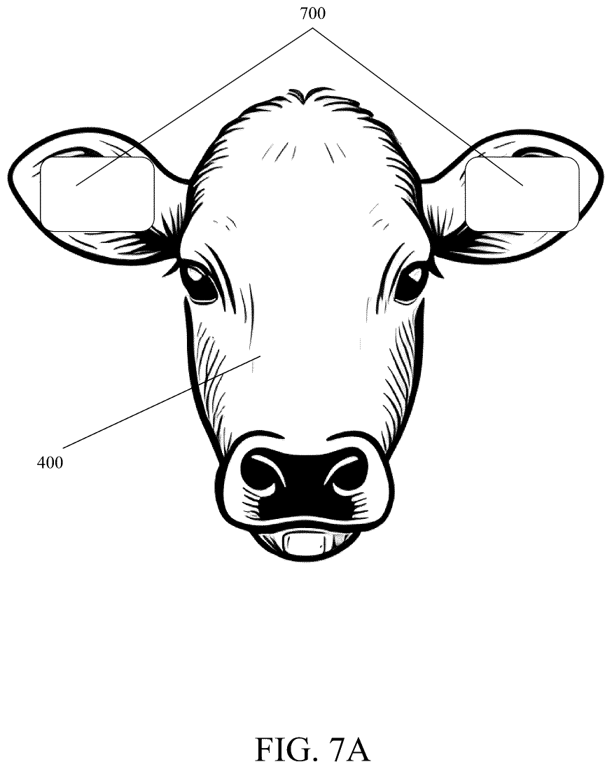

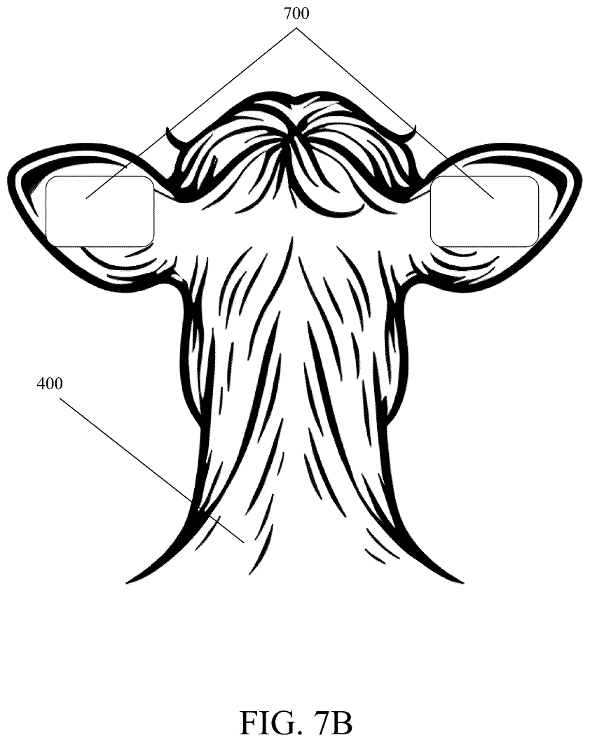

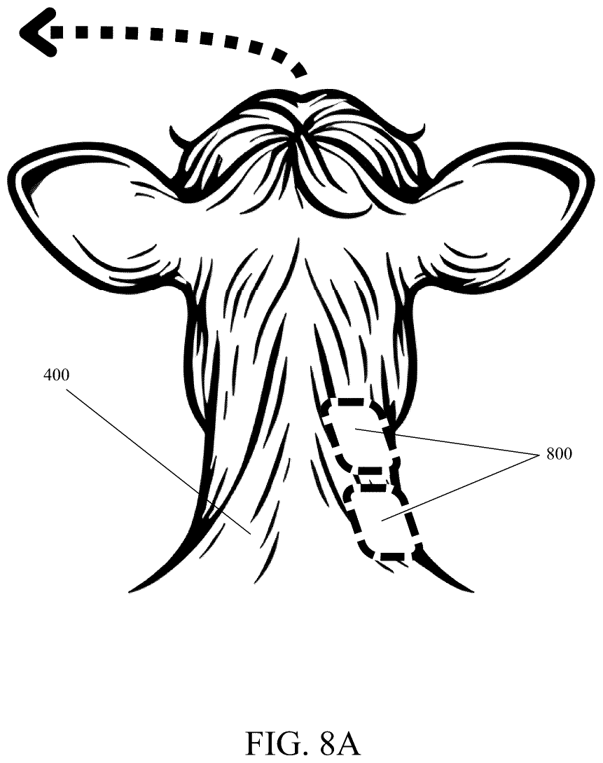

FIGS. 7A-7B show an example placement of a virtual fencing device 700, in accordance with example embodiments. Virtual fencing device 700 may be configured to include one or more ear tags allowing the virtual fencing device 700 to be attached to the ears of, for example, animal 400. Virtual fencing device 700 may be disposed on a front side of the ear or a back side of the ear. Virtual fencing device 700 may include an electrode that may be configured to perform EMS in contact with the ear. Virtual fencing device 700 may be substantially similar to virtual fencing device 150. In some embodiments, the microcontroller 130 may be in a housing configured to be adhered to the animal 400 with one or more adhesives. The housing may be in communication with the one or more ear tags.

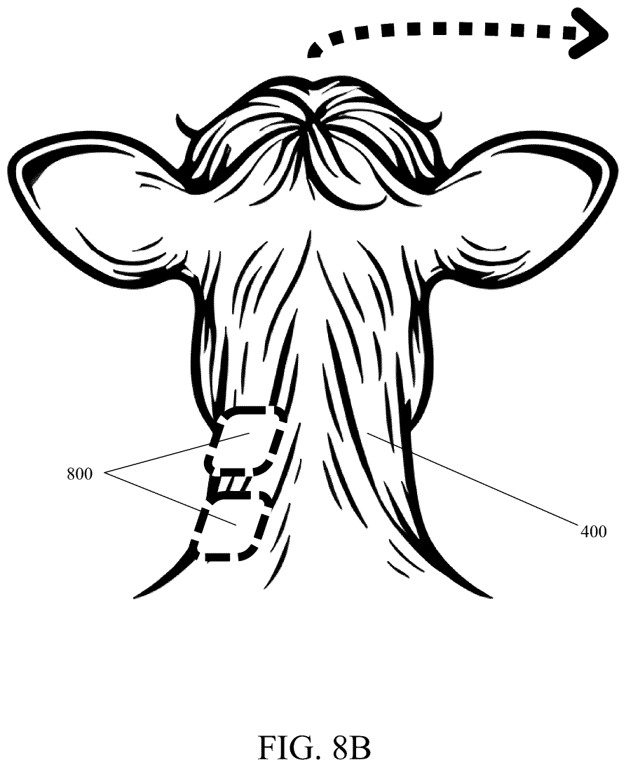

FIGS. 8A-8B show an example response to an illustrative electrode configuration, in accordance with example embodiments. As shown in FIG. 8A, when electrode control module 136 activates, electrodes 800 disposed on a right side of animal 400, the animal 400 may be steered left. The electrodes 800 may be activated to provide a tactile sensation which animal 400 may be trained to respond to such that electrodes 800 being activated on the right side of animal 400 may trigger a response in animal 400 to turn left. In some embodiments, electrodes 800 may be activated to provide a muscle contraction which may prevent the muscles on the right side of animal 400 from moving, which may steer animal 400 left. As shown in FIG. 8B, when electrode control module 136 activates, electrodes 800 disposed on a left side of animal 400, the animal 400 may be steered right. The electrodes 800 may be activated to provide a tactile sensation which animal 400 may be trained to respond to such that electrodes 800 being activated on the left side of animal 400 may trigger a response in animal 400 to turn right. In some embodiments, electrodes 800 may be activated to provide a muscle contraction which may prevent the muscles on the left side of animal 400 from moving, which may steer animal 400 right. Electrodes 800 may be any one of electrodes 210, electrodes 240, electrodes 270, electrodes 340, and electrodes 600.

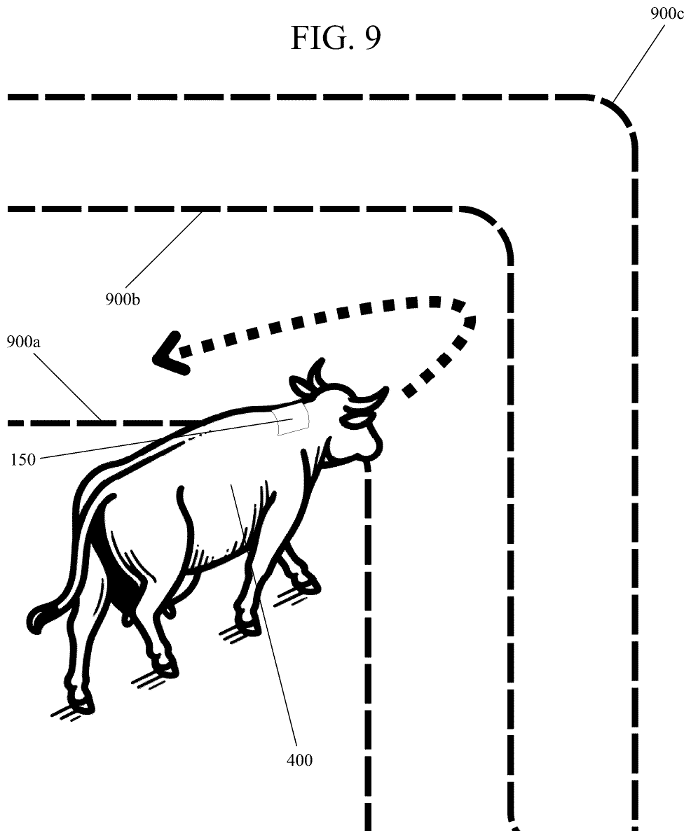

FIG. 9 shows an example implementation of a virtual fencing device 150, in accordance with example embodiments. Animal 400 may be equipped with virtual fencing device 150. As animal 400 approaches a virtual boundary 900a, position module 134 may determine that the position of the animal 400 relative to virtual boundary 900a is below a threshold distance. Position module 134 may notify microcontroller 130, and in response, microcontroller 130 may instruct electrode control module 136 to activate one or more electrodes of virtual fencing device 150. Electrode control module 136 may activate the one or more electrodes immediately or gradually. In some embodiments, electrode control module 136 may activate the one or more electrodes to create a tactile sensation for animal 400. If animal 400 is able to move past virtual boundary 900a, position module 134 may determine that the position of the animal 400 relative to virtual boundary 900b is below a threshold distance. Position module 134 may notify microcontroller 130, and in response, microcontroller 130 may instruct electrode control module 136 to intensify the signal to the one or more electrodes. Electrode control module 136 may intensify the signal by at least one of increasing the transmitted voltage, increasing the current, increasing the amplitude, adjusting the type of the signal, and/or increasing the frequency of the signal. In some embodiments, electrode control module 136 may intensify the one or more electrodes to induce muscle contraction for animal 400. For example, a current between about 1 mA and about 5 mA may be transmitted for creating a tactile sensation, and a current between about 6 mA and about 30 mA may be transmitted for inducing muscle contraction. If animal 400 is able to move past virtual boundary 900b, position module 134 may determine that the position of the animal 400 relative to virtual boundary 900c is below a threshold distance. Position module 134 may notify microcontroller 130, and in response, microcontroller 130 may instruct electrode control module 136 to intensify the signal to the one or more electrodes. Electrode control module 136 may intensify the signal as described above.

When position module 134 determines that the position of animal 400 relative to virtual boundary 900c is above the threshold distance, position module 134 may notify microcontroller 130, and in response, microcontroller 130 may instruct electrode control module 136 to decrease the signal. Electrode control module 136 may decrease the signal by at least one of decreasing the voltage, decreasing the current, decreasing the amplitude, adjusting the type of signal, and/or decreasing the frequency. Once position module 134 determines that the position of animal 400 relative to virtual boundary 900a is above the threshold distance, microcontroller 130 may instruct electrode control module 136 to deactivate the one or more electrodes.

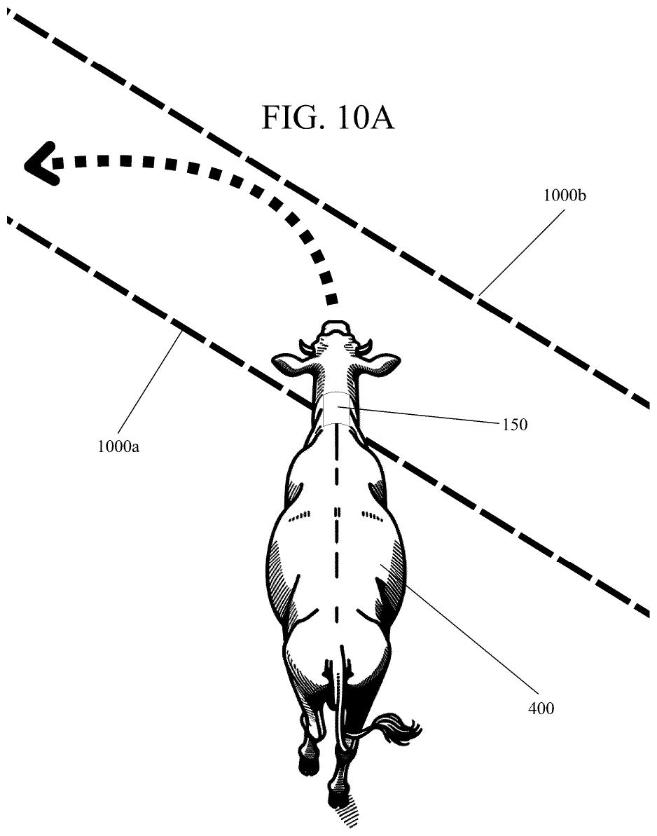

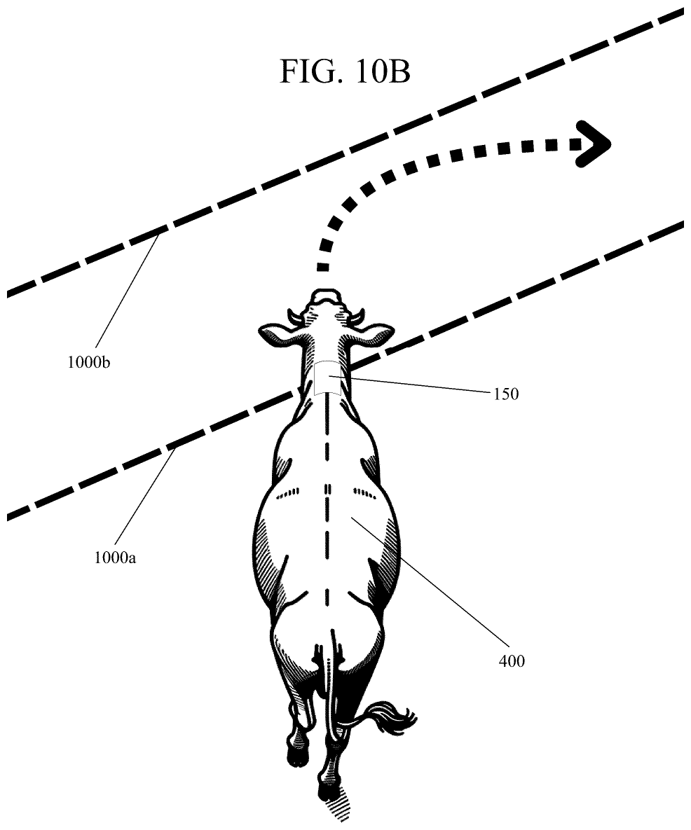

FIGS. 10A-B show an example implementation of a virtual fencing device 150, in accordance with example embodiments. Inertial measurement unit module 138 may determine a direction and acceleration of an animal 400. As shown in FIG. 10A, when animal 400 is approaching a virtual boundary 1000a at an angle such that a right side of virtual fencing device 150 is nearer the virtual boundary 1000a than a left side of virtual fencing device 150, inertial measurement unit module 138 may notify microcontroller 130. If position module 134 determines that the position of the animal 400 relative to virtual boundary 1000a is below a threshold distance, microcontroller 130 may instruct electrode control module 136 to activate electrodes on virtual fencing device 150 disposed on a right side of the animal 400 to turn the animal 400 to the left to avoid passing the virtual boundary 1000a. In some embodiments, electrode control module 136 may activate the electrodes to create a tactile sensation for animal 400. If animal 400 does pass virtual boundary 1000a, electrode control module 136 may intensify the electrode signal to steer animal 400 away from virtual boundary 1000b.

As shown in FIG. 10B, when animal 400 is approaching a virtual boundary 1000a at an angle such that a left side of virtual fencing device 150 is nearer the virtual boundary 1000a than the right side, inertial measurement unit module 138 may notify microcontroller 130. If position module 134 determines that the position of the animal 400 relative to virtual boundary 1000a is below a threshold distance, microcontroller 130 may instruct electrode control module 136 to activate electrodes disposed on the left side may be activated to turn the animal 400 to the right to avoid passing the virtual boundary 1000a. If animal 400 does pass virtual boundary 1000a, electrode control module 136 may intensify the electrode signal to steer animal 400 away from virtual boundary 1000b.

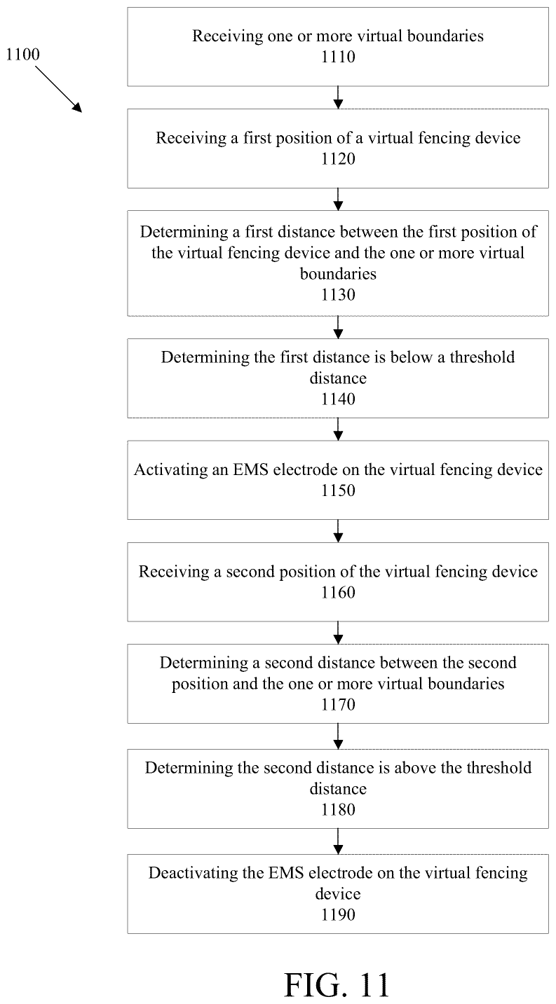

FIG. 11 shows an example process 1100 of virtual fencing according to some embodiments of the disclosure. Microcontroller 130 can perform process 1100. Process 1100 may begin at step 1110.

At 1110, microcontroller 130 may receive one or more virtual boundaries. Microcontroller 130 may receive the one or more virtual boundaries via communication module 132 from a server 120 and/or a mesh network of devices.

At 1120, microcontroller 130 may receive a first position of a virtual fencing device. Microcontroller 130 may receive the first position via position module 134.

At 1130, microcontroller 130 may determine a first distance between the first position of the virtual fencing device and the one or more virtual boundaries.

At 1140, microcontroller 130 may determine the first distance is below a threshold distance. Microcontroller 130 may store threshold distances for each virtual boundary. In some embodiments, microcontroller 130 may receive a direction and an acceleration of the virtual fencing device via inertial measurement unit module 138. Microcontroller 130 may determine the angle at which the virtual fencing device is approaching the virtual boundary.

At 1150, microcontroller 130 may activate an electrode that may be configured to perform EMS on the virtual fencing device. Microcontroller 130 may instruct electrode control module 136 to activate the electrode. Electrode control module 136 may immediately or gradually activate the electrode. In some embodiments, electrode control module 136 may first transmit a low voltage and frequency pulse to the electrode when activated. The low voltage and frequency pulse may induce a tactile sensation in a stimulated muscle. If inertial measurement unit module 138 determines that the direction of the virtual fencing device is toward the virtual boundary after the low voltage and frequency pulse has been activated, microcontroller 130 may instruct electrode control module 136 to intensify the signal to the electrode. Electrode control module 136 may intensify the signal by one or more of increasing the voltage, increasing the current, increasing the amplitude, adjusting the type of signal, and/or increasing the frequency. In some embodiments, electrode control module 136 may intensify the signal by increasing the voltage to a medium voltage. In some embodiments, a current between about 1 mA and about 5 mA may be transmitted for creating a tactile sensation, and a current between about 6 mA and about 30 mA may be transmitted for inducing muscle contraction. If inertial measurement unit module 138 determines that the direction of the virtual fencing device is away from the virtual boundary after the signal has been intensified, microcontroller 130 may instruct electrode control module 136 to decrease the intensity of the signal to the electrode. In some embodiments, electrode control module 136 may decrease the intensity by decreasing the voltage to the low voltage pulse and/or decreasing the current to the low current pulse.

In some embodiments, microcontroller 130 may instruct electrode control module 136 to activate the electrode based on the determination of the first distance being below the threshold distance and the determination of the approach angle. The electrode may be disposed on a first side of the virtual fencing device. When microcontroller 130 determines that the approach angle corresponds to the first side being nearer to the virtual boundary than a second side of the virtual fencing device, microcontroller 130 may instruct electrode control module 136 to activate the electrode. In some embodiments, there may be a second electrode on the second side of the virtual fencing device. Microcontroller 130 may be configured to independently control the electrodes through electrode control module 136 and may determine which EMS electrode to activate based on which side of the virtual fencing device is nearer to the virtual boundary.

At 1160, microcontroller 130 may receive a second position of the virtual fencing device. Microcontroller 130 may receive the second position via position module 134.

At 1170, microcontroller 130 may determine a second distance between the second position and the one or more virtual boundaries.

At 1180, microcontroller 130 may determine the second distance is above the threshold distance. Microcontroller 130 may store threshold distances for each virtual boundary.

At 1190, microcontroller 130 may deactivate the electrode on the virtual fencing device. Microcontroller 130 may instruct electrode control module 136 to deactivate the electrode.

In some embodiments, microcontroller 130 may receive a second set of virtual boundaries separate from the first set of virtual boundaries via communication module 132. Microcontroller 130 may determine via position module 134 that the virtual fencing device is outside the second set of virtual boundaries. Microcontroller 130 may instruct electrode control module 136 to activate the electrode. When inertial measurement unit module 138 determines a direction of the virtual fencing device is towards the second set of virtual boundaries, microcontroller 130 may instruct electrode control module 136 to deactivate the electrode. Microcontroller 130 may monitor to the position and the direction via position module 134 and inertial measurement unit module 138 and may instruct electrode control module 136 to activate the electrode if the virtual fencing device has stopped moving or is not moving towards the second set of virtual boundaries.

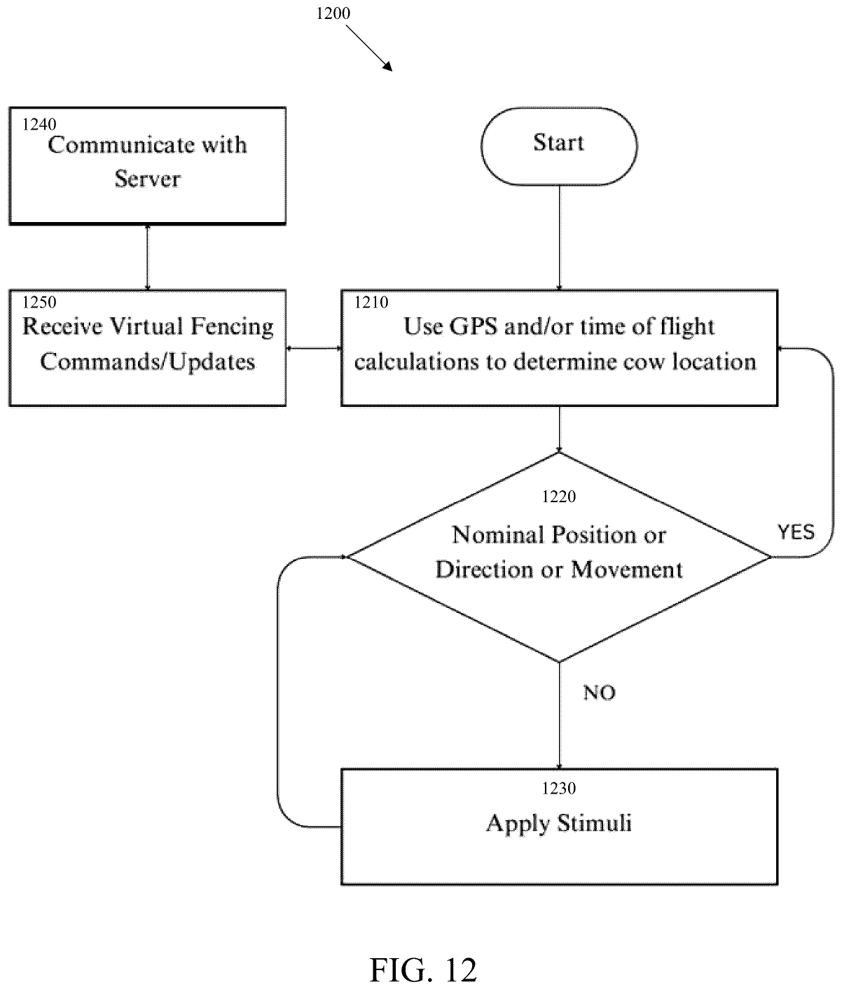

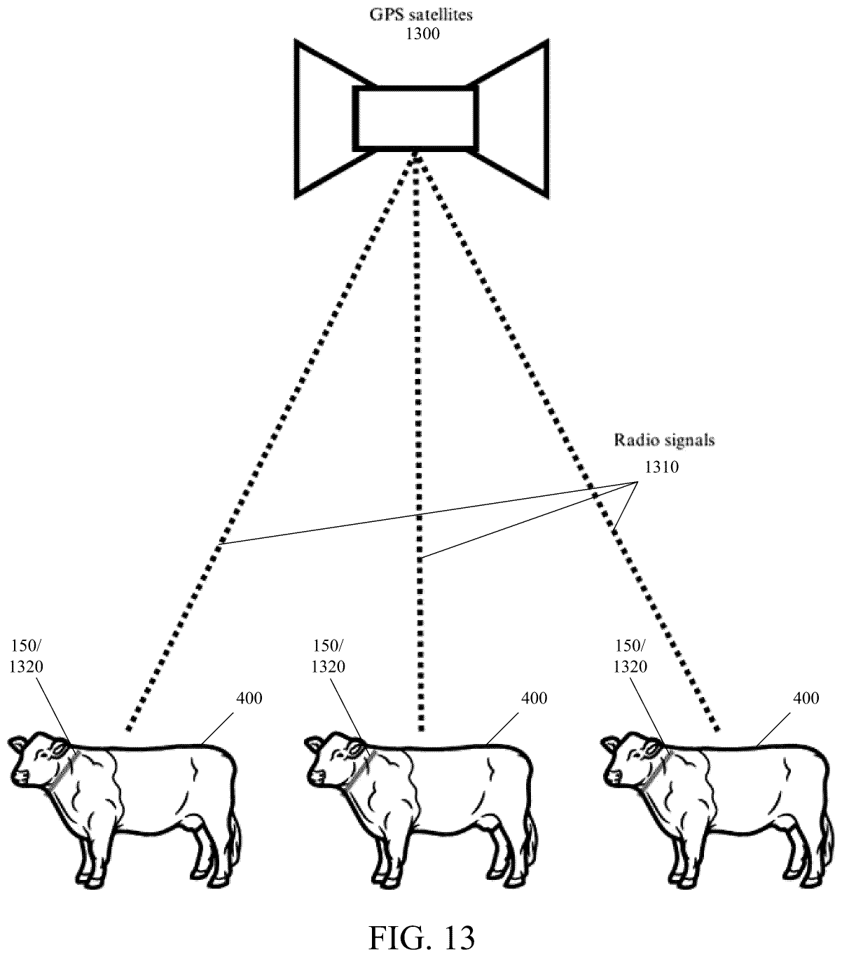

FIG. 12 depicts a flowchart illustrating a process 1200 integrating time-of-flight (ToF) positioning within a virtual fencing system. Process 1200 may accommodate central and/or peripheral devices for livestock tracking. Microcontroller 130 can perform process 1200. Process 1200 may begin at step 1210.

At 1210, microcontroller 130 can use GPS and/or ToF calculations to determine an animal's location. In this process, microcontroller 130 can begin by detecting the type of collar used (e.g., central or peripheral) and adjust its operation accordingly. For central devices, microcontroller 130 can use geolocational coordinates to track the animal's location and may supplement this with time-of-flight data for enhanced accuracy or when traditional positional services are weak. In the case of peripheral collars, microcontroller 130 can rely entirely on ToF trilateration, using signals from at least three central devices with known locations. The time of flight may be calculated by measuring the time delay between when the central devices send and when the peripheral receives these radiofrequency signals, allowing microcontroller 130 to determine the distance between the central and peripheral devices. This data is then used in trilateration calculations to pinpoint the animal's position. Details of how microcontroller 130 can locate animals for each of the collar types are described in further detail below.

At 1220, microcontroller 130 can determine whether the location detected at 1210 indicates the animal is within a virtual fence and/or approaching a virtual fence boundary. At 1230, if the animal needs to be moved, stimuli may be applied. The determination at 1220 and stimulation at 1230 can proceed as described above with reference to the preceding figures, for example.

Also similar to the embodiments described above, at 1240, microcontroller 130 can communicate with a central server. At 1250, if the communication indicates that virtual fencing commands and/or positions have changed, microcontroller 130 can update such information for use with future instances of microcontroller 130 determining animal location at 1210.

FIG. 13 depicts an example implementation of a virtual fencing device using traditional positional services. Satellite 1300, which may be a GPS satellite for example, may communicate with one or more receivers within one or more virtual fencing devices 150 equipped with GPS receivers 1320 worn by one or more animals 400 through radio signals 1310. By communicating with a constellation of satellites 1310 in orbit around the earth, virtual fencing device 150 can be located. GPS is presented as a well-known example of geolocation by satellite 1300, but any available positioning system may be substituted without departing from the scope of the illustrated implementation.

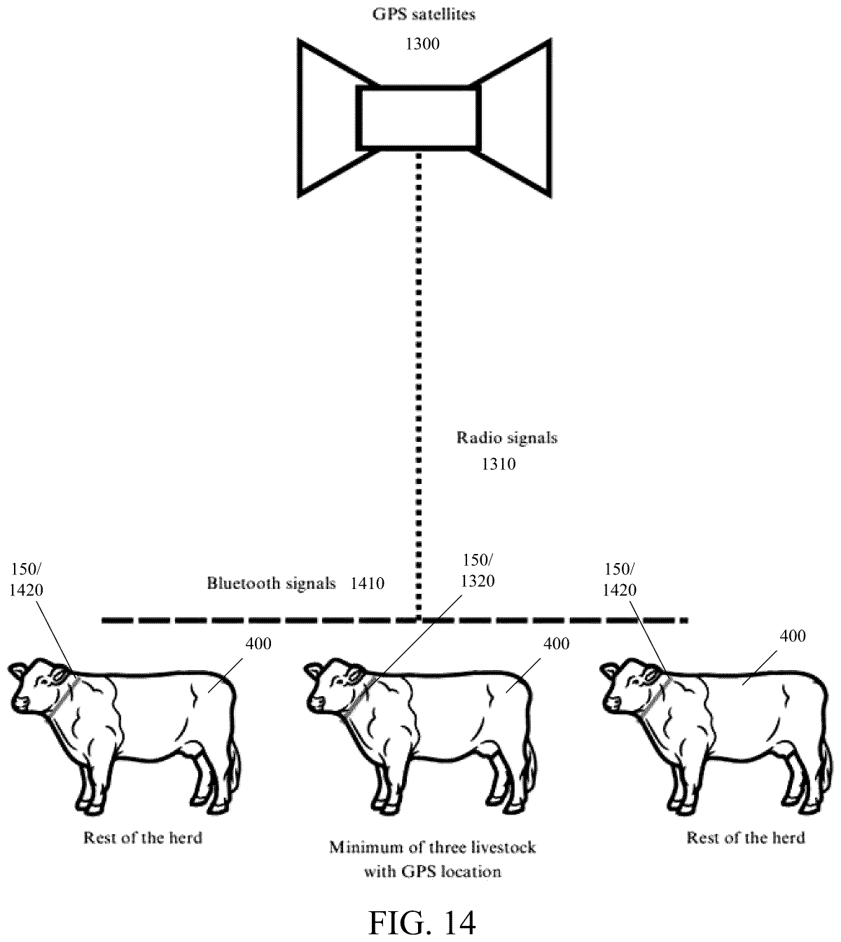

FIG. 14 depicts an example of integrating the traditional positional satellite process with ToF measurements. As noted above, in embodiments wherein some animals 400 wear virtual fencing devices 150 configured as central devices with GPS receivers 1320, these animals 400 can be tracked using GPS in the manner shown in FIG. 13. However, some embodiments may only equip a subset of all animals 400 being tracked with central devices, for example to reduce cost and/or complexity of virtual fencing devices 150 worn by other animals outside the subset. In this example, at least three central devices including GPS receivers 1320, with known locations, may act as anchors that can be used in trilateration calculations. Other animals 400 can wear virtual fencing devices 150 equipped with local transceivers 1420 (e.g., using Bluetooth signals 1410) to communicate with the anchors for trilateration. Bluetooth is presented as a well-known example of local area communication, but any available data communication technology may be substituted without departing from the scope of the illustrated implementation. It may be useful to select a data communication technology allowing for local transceivers 1420 to have reduced complexity and/or power usage compared with GPS receivers 1320.

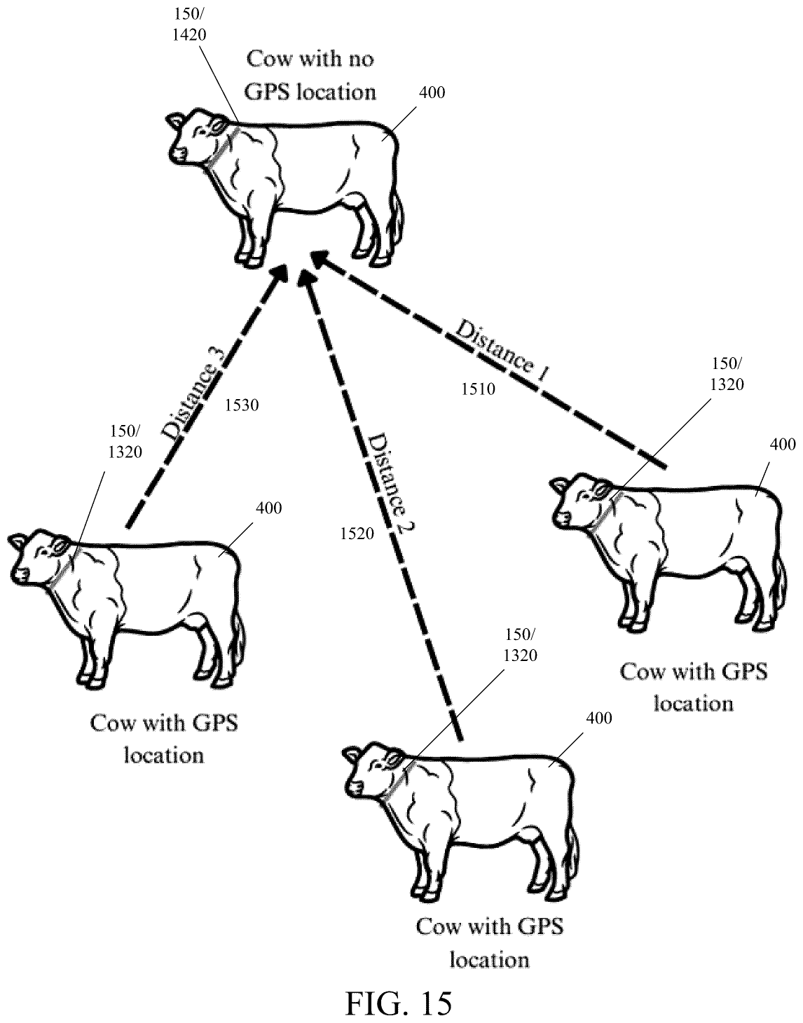

FIG. 15 depicts an example implementation of animal networks used to determine the positioning of peripheral units within a virtual fencing system. In this approach, animal-worn peripheral devices 150 equipped with local transceivers 1420 form a network by communicating with each other and with central devices 150 equipped with GPS receivers 1320 in proximity. Using ToF measurements, each peripheral device 150 can calculate its distance 1510, 1520, 1530 from nearby transceivers 1320/1420 and other animals 400 in the network. By leveraging trilateration with multiple reference points, microcontroller(s) 130 can determine the precise position of each animal 400. This network-based positioning allows for accurate tracking without reliance on traditional positioning systems, enabling efficient virtual fence management in satellite-limited environments and foregoing the battery intensive traditional positional services for a majority of animals 400 in the group.

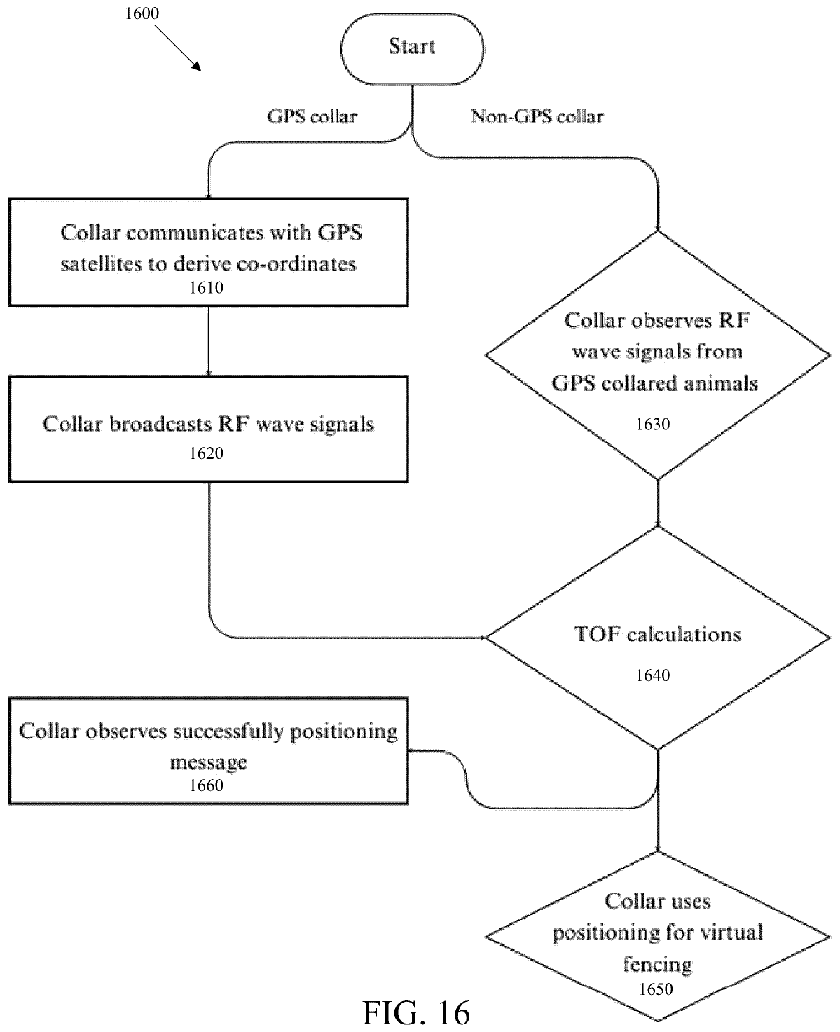

FIG. 16 depicts a flowchart of a ToF calculation process 1600 involving central devices 150 equipped with GPS receivers 1320 and peripheral devices 150 equipped with local transceivers 1420. Microcontroller(s) 130 of respective device(s) can perform process 1600. Process 1600 may begin at step 1610.

At 1610, microcontroller 130 of a central device can obtain the location of the animal 400 wearing the central device using GPS satellite signals or other positional service signals. At 1620, microcontroller 130 can cause the central device to broadcast local signals (e.g., Bluetooth or other RF signals). For example, in addition to the GPS receiver 1320, the central device may include a local transceiver 1420 or other transmitter or transceiver that can broadcast the local signals. Multiple (e.g., at least three) central devices can perform the actions at 1610 and 1620.

At 1630, microcontroller 130 of a peripheral device can receive the broadcast from the multiple central devices (e.g., via transceiver 1420). At 1640, microcontroller 130 of the peripheral device can perform a ToF calculation, calculating the time delay between the central devices in proximity. These distances can be used in trilateration to pinpoint the animal's location. To perform trilateration, microcontroller 130 can use the peripheral device's unknown location (x,y,z), the known location of the three central devices (denoted by subscript 1, 2, and 3) and the three distances between the central devices and the peripheral device (d₁,d₂,d₃). Microcontroller 130 may first take the three equations:

$${( x - {x}_{1} )}^{2} + {( y - {y}_{1} )}^{2} = {d}_{1} ,$$

$${( x - {x}_{2} )}^{2} + {( y - {y}_{2} )}^{2} = {d}_{2} , and$$

$${( x - {x}_{3} )}^{2} + {( y - {y}_{3} )}^{2} = {d}_{3} .$$

Microcontroller 130 may then use subtraction to find

$$( {x}_{1}^{2} - {x}_{2}^{2} ) + ( {y}_{1}^{2} - {y}_{2}^{2} ) + 2 ( {x}_{2} - {x}_{1} ) x + 2 ( {y}_{2} - {y}_{1} ) y = {d}_{1}^{2} - {d}_{2}^{2} and$$

$$( {x}_{2}^{2} - {x}_{3}^{2} ) + ( {y}_{2}^{2} - {y}_{3}^{2} ) + 2 ( {x}_{3} - {x}_{2} ) x + 2 ( {y}_{3} - {y}_{2} ) y = {d}_{2}^{2} - {d}_{3}^{2} .$$

Microcontroller 130 may now have two unknowns (x,y) and two equations, which microcontroller 130 can use to solve for x and y. A third variable z can be introduced for all devices to additionally find the altitude of the peripheral device. Based on the location as determined at 1640, at 1650, microcontroller 130 of the peripheral device can perform virtual fencing activities such as those described above, including providing stimuli to animal 400, for example. At 1660, the peripheral device can report, and the central device can receive, indication that the positioning was performed successfully by the peripheral device. As shown in FIG. 16, both central and peripheral methods can operate in parallel, ensuring reliable and precise positioning.

In the above examples, the central devices are depicted as being worn by animals 400. However, it should be noted that in some embodiments, the central devices may comprise GPS (or other geolocation) transceivers placed within a virtual fence area but not necessarily worn by animals 400. In such embodiments, the ToF positioning for individual animals 400 wearing individual peripheral devices can proceed in the same way as described above with respect to FIGS. 12-16.

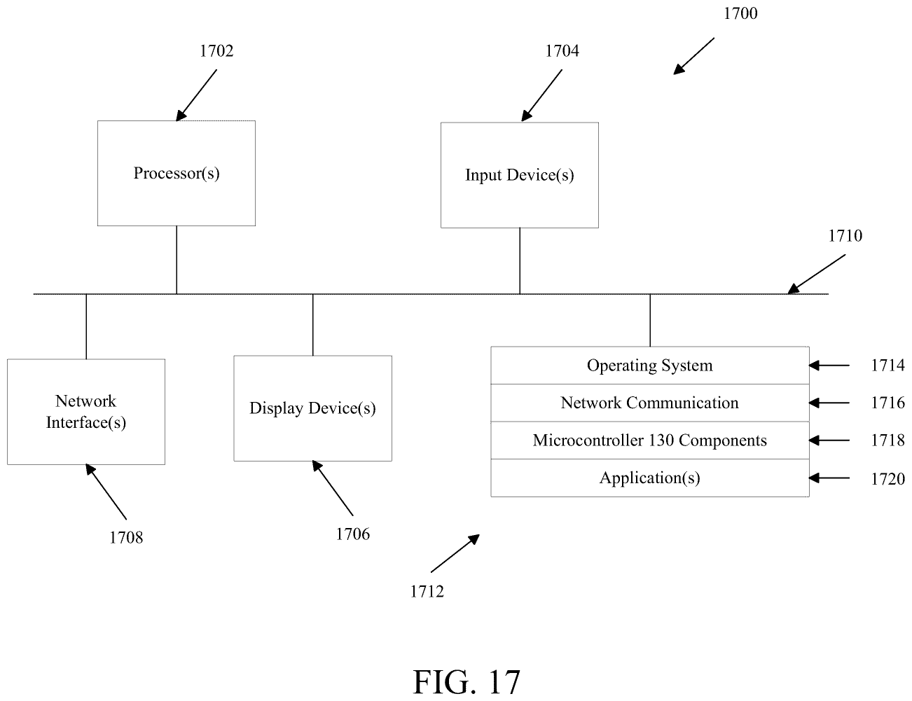

FIG. 17 shows a block diagram of an example computing device 1700 that may implement various features and processes, according to some embodiments of the disclosure. For example, computing device 1700 may function as the server 120, the clients 110, the virtual fencing device 150, or a portion or combination thereof in some embodiments. Additionally, the computing device 1700 may partially or wholly host and deploy microcontroller 130. The computing device 1700 may also perform one or more steps of process 1100. The computing device 1700 may be implemented on any electronic device that runs software applications derived from compiled instructions, including without limitation personal computers, servers, smart phones, media players, electronic tablets, game consoles, email devices, etc. In some implementations, the computing device 1700 may include one or more processors 1702, one or more input devices 1704, one or more display devices 1706, one or more network interfaces 1708, and one or more computer-readable media 1712. Each of these components may be coupled by a bus 1710.

Display device 1706 includes any display technology, including but not limited to display devices using Liquid Crystal Display (LCD) or Light Emitting Diode (LED) technology. Processor(s) 1702 uses any processor technology, including but not limited to graphics processors and multi-core processors. Input device 1704 includes any known input device technology, including but not limited to a keyboard (including a virtual keyboard), mouse, track ball, and touch-sensitive pad or display. Bus 1710 includes any internal or external bus technology, including but not limited to ISA, EISA, PCI, PCI Express, USB, Serial ATA or FireWire. Computer-readable medium 1712 includes any non-transitory computer readable medium that provides instructions to processor(s) 1702 for execution, including without limitation, non-volatile storage media (e.g., optical disks, magnetic disks, flash drives, etc.), or volatile media (e.g., SDRAM, ROM, etc.).

Computer-readable medium 1712 includes various instructions for implementing an operating system 1714 (e.g., Mac OS®, Windows®, Linux). The operating system 1714 may be multi-user, multiprocessing, multitasking, multithreading, real-time, and the like. The operating system 1714 performs basic tasks, including but not limited to: recognizing input from input device 1704; sending output to display device 1706; keeping track of files and directories on computer-readable medium 1712; controlling peripheral devices (e.g., disk drives, printers, etc.) which can be controlled directly or through an I/O controller; and managing traffic on bus 1710. Network communications instructions 1716 establish and maintain network connections (e.g., software for implementing communication protocols, such as TCP/IP, HTTP, Ethernet, telephony, etc.).

Microcontroller 130 components 1718 may include instructions for performing the processing described herein. For example, microcontroller 130 components 1718 may provide instructions for performing any and/or all of process 1100, and/or other processing as described above. Application(s) 1720 may comprise an application that uses or implements the processes described herein and/or other processes. The processes may also be implemented in the operating system 1714.

The described features may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment. In one embodiment, this may include Python. The computer programs therefore are polyglots.

Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

To provide for interaction with a user, the features may be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include clients and servers. A client and server may generally be remote from each other and may typically interact through a network. The relationship of client and server may arise by virtue of computer programs running on the respective computers and having a client-server relationship to each other.

One or more features or steps of the disclosed embodiments may be implemented using an API. An API may define one or more parameters that are passed between a calling application and other software code (e.g., an operating system, library routine, function) that provides a service, that provides data, or that performs an operation or a computation.

The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API.

In some implementations, an API call may report to an application the capabilities of a device running the application, such as input capability, output capability, processing capability, power capability, communications capability, etc.

Additional examples of the presently described method and device embodiments are suggested according to the structures and techniques described herein. Other non-limiting examples may be configured to operate separately or can be combined in any permutation or combination with any one or more of the other examples provided above or throughout the present disclosure.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

It should be noted that the terms “including” and “comprising” should be interpreted as meaning “including, but not limited to”. If not already set forth explicitly in the claims, the term “a” should be interpreted as “at least one” and “the”, “said”, etc. should be interpreted as “the at least one”, “said at least one”, etc. Furthermore, it is the Applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

1. A virtual fencing device, comprising:
an electrode configured to perform electrical muscle stimulation (EMS);
a positioning system configured to determine a position of the device; and
a microcontroller engaged with the electrode and the positioning system, the microcontroller being configured to activate the electrode in response to the position of the device relative to one or more virtual boundaries.

2. The virtual fencing device of claim 1, further comprising:
a communication system engaged with the microcontroller, the communication system configured to communicate with a central server and/or a mesh network storing the one or more virtual boundaries.

3. The virtual fencing device of claim 2, wherein the communication system is configured to connect the microcontroller to the central server and/or the mesh network such that the one or more virtual boundaries are updated on the microcontroller in response to an update of the one or more virtual boundaries on the central server and/or the mesh network.

4. The virtual fencing device of claim 1, further comprising:
an inertial measurement unit engaged with the microcontroller,
wherein the microcontroller is configured to determine a direction and acceleration of the virtual fencing device via the inertial measurement unit.

5. The virtual fencing device of claim 1, further comprising:
a neckband configured to house the electrode, the positioning system and the microcontroller.

6. The virtual fencing device of claim 5, wherein the electrode is a first electrode disposed on a first side of the neckband, the device further comprising:
a second electrode disposed on a second side of the neckband,
wherein the microcontroller is configured to independently control the first electrode and the second electrode.

7. The virtual fencing device of claim 5, wherein the electrode is disposed on the neckband and wherein the electrode is connected to a snap fit connector, the snap fit connector configured to engage with the microcontroller.

8. The virtual fencing device of claim 1, further comprising:
a hybrid super capacitor storage device configured to be engaged with the microcontroller.

9. The virtual fencing device of claim 1, further comprising:
one or more ear tags configured to house the electrode.

10. The virtual fencing device of claim 1, wherein the microcontroller is configured to adjust a current pulse provided to the electrode.

11. The virtual fencing device of claim 10, wherein the microcontroller is configured to provide at least a low current pulse and a medium current pulse to the electrode.

12. The virtual fencing device of claim 1, further comprising:
a pogo pin configured to connect the electrode to the microcontroller.

13. The virtual fencing device of claim 1, wherein the positioning system is configured to determine the position using signals from at least one geolocation signal source.

14. The virtual fencing device of claim 1, wherein the positioning system is configured to determine the position by receiving at least three position signals from at least three external virtual fencing devices and performing time-of-flight trilateration using the at least three position signals.

15. A method, comprising:
receiving, by a computing system comprising at least one processor, one or more virtual boundaries;
receiving, by the computing system, a first position of a virtual fencing device;
determining, by the computing system, a first distance between the first position of the virtual fencing device and the one or more virtual boundaries;
determining, by the computing system, the first distance is below a threshold distance;
activating, by the computing system, an electrode on the virtual fencing device in response to the determining that the first distance is below the threshold distance, wherein the electrode is configured to perform EMS;
receiving, by the computing system, a second position of the virtual fencing device;
determining, by the computing system, a second distance between the second position and the one or more virtual boundaries;
determining, by the computing system, the second distance is above the threshold distance; and
deactivating, by the computing system, the electrode on the virtual fencing device in response to the determining that the second distance is above the threshold distance.

16. The method of claim 15, further comprising:
receiving, by the computing system, a direction and acceleration of the virtual fencing device; and
determining, by the computing system, the direction is toward the one or more virtual boundaries;
wherein the activating the electrode is in response to the determination of the direction and the determination of the first distance.

17. The method of claim 16, wherein the electrode is disposed on a first side of the virtual fencing device, wherein the determining the direction is toward the one or more virtual boundaries comprises:
determining, by the computing system, the direction is at an angle relative to the one or more virtual boundaries such that the first side of the virtual fencing device is nearer the one or more virtual boundaries than a second side of the virtual fencing device.

18. The method of claim 16, wherein activating the electrode comprises:
applying, by the computing system, a low current pulse to the electrode;
determining, by the computing system, the direction is toward the one or more virtual boundaries;
applying, by the computing system, a medium current pulse to the electrode;
determining, by the computing system, the direction is away from the one or more virtual boundaries; and
decreasing, by the computing system, the medium current pulse to the low current pulse for the electrode.

19. The method of claim 15, wherein the electrode comprises a plurality of electrodes.

20. The method of claim 15, wherein the one or more virtual boundaries are a first set of virtual boundaries, the method further comprising:
receiving, by the computing system, a second set of virtual boundaries comprising one or more virtual boundaries;
receiving, by the computing system, a third position of the virtual fencing device;
determining, by the computing system, the third position is outside the second set of virtual boundaries; and
activating, by the computing system, the electrode in response to the determining that the third position is outside of the second set of virtual boundaries.
